(19) United States
(12) Patent Application Publication
(10) Pub. No.: US 2023/0331994 A1
(43) Pub. Date: Oct. 19, 2023

(54) AEROSOL COMPOSITION FOR FORMING PEELABLE COATINGS

(71) Applicant: DEFENDA PTY LTD AS TRUSTEE FOR UNI-TUFF GLOBAL TRUST, Red Hill (AU)

(72) Inventor: Richard West, Red Hill (AU)

(21) Appl. No.: 17/753,453

(22) PCT Filed: Sep. 3, 2020
(86) PCT No.: PCT/AU2020/050922

§ 371 Date: Mar. 3, 2022

Related U.S. Application Data
(60) Provisional application No. 62/895,319, filed on Sep. 3, 2019.

(30) Foreign Application Priority Data
Sep. 5, 2019 (AU) 2019903278

(51) Int. Cl. C09D 5/02; C09D 5/20; C09D 5/08; C09D 7/43; C09D 7/63; C09D 7/40; C09D 7/61

(52) U.S. Cl. CPC C09D 5/021; C09D 5/20; C09D 5/08; C09D 7/43; C09D 7/63; C09D 7/66; C09D 7/61; C09D 127/06

(57) ABSTRACT

A quick drying aerosol composition for coating a metal substrate for inhibiting corrosion, wherein droplets of the composition are adapted to be discharged from an aerosol spray device, the aerosol composition comprises: an emulsion of a resin in an amount in the range of 10 wt % to 60 wt % selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof; one or more 100 thickening or anti-caking agents in amount in the range of 0.5 wt % to 7 wt %; a plasticizer in an amount in the range of 1 wt % to 15 wt % compatible with the resin; and a non-aqueous carrier/solvent in an amount 5 wt % to 35 wt %.

### TECHNICAL FIELD

The present invention relates to an aerosol composition adapted to be dispensed in an atomized spray from a pressurised aerosol container for inhibiting corrosion on metallic surfaces.

### BACKGROUND

Any references to methods, apparatus or documents of the prior art are not to be taken as constituting any evidence or admission that they formed, or form part of the common general knowledge.

It is known that most bare metals are likely to corrode if exposed to moisture and other environmental factors. Traditional paints for metal that are designed for corrosion prevention preserve the appearance and integrity of the surface. However, these paints adhere strongly to the metal, and this adhesion is vital to the corrosion protection they provide. Typical paints are designed to be difficult to remove or strip away and designed to for long periods of time. However, bare metal parts (uncoated with exposed metallic surfaces) that are temporarily stored or transported during processing often require a coating that will protect against corrosion and be easily removed just prior to final assembly. Considering strict specifications of many OEMs and suppliers, corrosion is not an option.

Readily peelable coating compositions that can be easily applied on metallic substrates for inhibiting corrosion are known in the art. Such peelable coating formulations provide corrosion and weather resistance that protects bare metal products, without leaving any residue behind. However, one of the problems associated with such formulations is that such formulations are polymer based (contain co-polymers dispersed in a non-aqueous solvent) which are difficult if not impossible to discharge by using an aerosol can. It has been found that dispensing currently known peelable corrosion inhibiting polymeric coatings through aerosol dispensers results in non-uniform coating which is not only aesthetically unattractive but also ineffective because the relatively high viscosity of polymers dispersed in such formulations prohibits proper atomisation of the spray dispersed from a conventional aerosol valve used in conjunction with known types of aerosol cans.

Unituff 452 is a commercially available coating (Unituff 452—details available at http://unituffglobal.com/wp-content/uploads/2018/02/04-U452-4-4L_1G. UT-Un ituff-452.pdf) that can be suitably coated on a metallic substrate. However, formulations such as but not limited to Unituff 452 are not readily suitable for application in an aerosol container. Initial attempts of using the Unituff 452 formulation in an aerosol can for spraying purposes resulted in producing an uneven coating due to the highly viscous nature of the Unituff 452 coating. The applicants attempted to initially add the Unituff 452 coating to an aerosol spray with up to 33% propellant such as DME. However, such dilution of the Unituff 452 did not bear any useful results. It was either very difficult to get the diluted Unituff 452 coating to be atomised sufficiently or even upon utilising specialised atomising valves, the coating formed by spraying such diluted 452 coating was very thin. As a result multiple coatings were required.

In view of the above, it is desirable to provide an improved aerosol formulation that addresses some of the deficiencies of the prior art.

### SUMMARY OF INVENTION

In a first aspect, the invention provides a quick drying aerosol composition for coating a metal substrate for inhibiting corrosion, wherein droplets of the composition are adapted to be discharged from an aerosol spray device, the aerosol composition comprises: an emulsion of a resin in an amount in the range of 10 wt % to 60 wt %, the resin being selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof; one or more thickening or anti-caking agents in amount in the range of 0.5 wt % to 7 wt %; a plasticizer in an amount in the range of 1 wt % to 15 wt % compatible with the resin; and a non-aqueous carrier/solvent in an amount 5 wt % to 35 wt %.

In an embodiment, the resin is one of the following: polyvinyl chloride, polyvinylidene chloride, polyvinyl acetate and poly (lower alkyl) acrylates.

In an embodiment, the group comprises polyvinyl chloride resins, polyvinyl acetate resins, vinyl chloride-vinyl acetate copolymeric resins, acrylic resins, polyvinyl alcohols.

In an embodiment, the resin is an amount in the range of 10 wt % to 30 wt % and more preferably in the range of 10 wt % to 20 wt %.

In an embodiment, the thickening or anti-caking agent comprises particulate silica such as fumed or amorphous or pyrogenous silica.

In an embodiment, the thickening or anti-caking agent is present in an amount ranging from 0.5 wt % to 4.5 wt % and more preferably between 2 wt % and 4 wt %.

In an embodiment, the thickening or anti-caking agent comprises hydrophobic particulate silica with a BET surface area in range of 50 to 300 m²/gm and more preferably 110 m²/gm.

In an embodiment, the plasticizer is a non-phthalate plasticizer.

In an embodiment, the quick drying aerosol composition in accordance with any one of the preceding claims further comprising a propellant such that volume ratio to the aerosol composition when contained in a pressurized aerosol dispenser at a pressure in range of 35-105 psi at 70° F., ranges from 80:20 to 50:50.

In an embodiment, the non-aqueous carrier/solvent comprises alcohols, such as methanol, ethanol, propanol and butanol; aliphatic hydrocarbons, such as hexane and pentane; aromatic hydrocarbons, such as benzene, toluene and xylene; ketones, such as acetone and methylethylketone; ethers such as diethylether, dioxane and tetrahydrofuran; esters, such as ethyl acetate, propyl acetate and butyl acetate; and halogenated hydrocarbons, such as trichloroethylene and carbon tetrachloride.

In an embodiment, the propellant is selected from a group comprising one or more of the following: dimethyl ether, pentaflurodimethyl ether, Perfluorodimethyl ether and its derivatives.

In another aspect, the invention provides an aerosol spray device for applying a corrosion inhibiting composition on a metallic substrate, the device comprising: container for containing and pressurising the aerosol composition as described herein; a dispensing passageway having a discharge opening; and valve for dispensing the aerosol composition, a dip tube extending from the valve to the aerosol composition in the container, wherein in response to displacement of an actuator member into an open position, from the container into the dispensing passageway and out of the discharge opening.

In yet another aspect, the invention provides an aerosol paint product for inhibiting corrosion by coating a substrate with the product to form a strippable or peelable coating, the product comprising:

a container containing an aerosol composition comprising: an emulsion of a resin in an amount in the range of 10 wt % to 60 wt % selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof; one or more thickening or anti-caking agents in amount in the range of 0.5 wt % to 7 wt %; a plasticizer in an amount in the range of 1 wt % to 15 wt % compatible with the resin; and a non-aqueous carrier/solvent in an amount 5 wt % to 35 wt %;
a dispensing passageway having a discharge opening; and
valve for dispensing the aerosol composition,
a dip tube extending from the valve to the aerosol composition in the container, wherein in response to displacement of an actuator member into an open position, from the container into the dispensing passageway and out of the discharge opening.

In another aspect, the invention provides a method of producing an aerosol composition for coating a metal substrate for inhibiting corrosion, the method comprising the steps of:

providing a starting emulsion of a resin, the emulsion being in an amount in the range of 45 wt % to 85 wt %, the resin selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof;

dispersing one or more thickening or anti-caking agents in amount in the range of 0.5 wt % to 7 wt % through the emulsion to attain a uniformly dispersed emulsion mixture comprising the emulsion and the thickening or anti-caking agent; adding a plasticizer to the mixing amount in the range of 1 wt % to 15 wt % to the emulsion mixture; and

adding a non-aqueous solvent in an amount in the range of 5 wt to 35 wt % to the emulsion mixture after adding the plasticizer to form a blended mixture.

In an embodiment, the amount of resin in the starting emulsion is an amount in the range of 5 wt % to 25 wt % and more preferably in the range of 10 wt % to 20 wt %.

In an embodiment, the step of dispersing the thickening or anti-caking agents comprises using a saw tooth disperser for dispersing the thickening or anti-caking agents at a tip speed of with 5,000 feet per minute tip speed.

In an embodiment, the method of producing the aerosol composition further comprises the steps of:
filtering the blended mixture to separate any solid agglomerates from the blended mixture; and
pouring the filtered blended mixture into an aerosol container;
adding a propellant into the aerosol container and pressurising the aerosol container to a pressure in the range of 35-105 psi such that such that volume ratio of the propellant to the aerosol composition when contained in a pressurized aerosol dispenser ranges from 80:20 to 50:50.

In an embodiment, the starting emulsion is prepared by adding the resin in a range of 8 wt % to 25 wt % and more preferably in the range of 10 wt % to 20 wt % in a first group of solvents, the first group of solvents being in the range of 40 wt % to 70 wt % and more preferably in the range of 55 wt % to 65 wt %.

In an embodiment, the first group of solvents comprises one or more of alcohols, such as methanol, ethanol, propanol and butanol; aliphatic hydrocarbons, such as hexane and pentane; aromatic hydrocarbons, such as benzene, toluene and xylene; ketones, such as acetone and methylethylketone; ethers such as diethylether, dioxane and tetrahydrofuran; esters, such as ethyl acetate, propyl acetate and butyl acetate; and halogenated hydrocarbons, such as trichloroethylene and carbon tetrachloride.

In an embodiment, the starting emulsion is prepared by addition of a first group of plasticizers in the range of 5 wt % to 20 wt %, the plasticizers comprising one or more of the following: dioctyl adipate (DOA) and/or trioctyl metallate (TOTM); DOS: Dioctyl sebacate, TXIB: 2,2,4-trimethyl 1,3-pentanediol; diisobutyrate, TEHPA: Tri(2-ethylhexyl) phosphate, DEHPA: Di(2-ethylhexyl) phosphate, Eastman 168: bis(2-ethylhjexyl), 1,4-benzenedicarboxylate, TETM: Tri-2-ethylhexyl trimellitate; ESBO: Epoxidized soybean oil, DOTP: Dioctyl terephthalate; DINCH: Di-isononylcyclohexane-1,2-dicarboxylate.

In an embodiment, the starting emulsion is prepared by addition of a solvent soluble polyurethane dispersion in an amount in the range of 2 wt % to 5 wt %.

In yet another embodiment, the invention provides a method of coating a metallic substrate comprising the steps of:
applying a quick drying aerosol composition on the metal substrate to form a coating thereon for inhibiting corrosion;
   wherein droplets of the composition are adapted to be discharged from an aerosol spray device and wherein the aerosol composition comprises: an emulsion of a resin, the emulsion being in an amount in the range of 45 wt % to 85 wt % and wherein the resin is selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof; one or more thickening or anti-caking agents in amount in the range of 0.5 wt % to 7 wt %; a plasticizer in an amount in the range of 1 wt % to 15 wt % compatible with the resin; and a non-aqueous carrier/solvent in an amount 5 wt % to 35 wt %.

It is to be understood that the composition described herein is in no way limited by its end use and may be suitable for use on non-metallic substrates.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a schematic view of an aerosol spray device 100 in accordance with an embodiment.

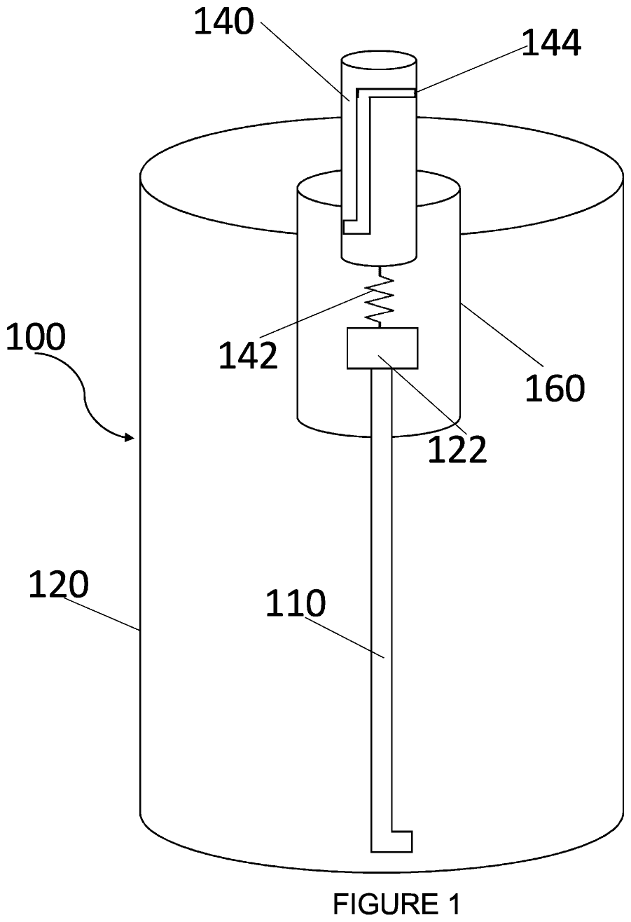

### DETAILED DESCRIPTION OF PREFERRED EMBODIMENTS

The presently described embodiment of the aerosol composition comprises an emulsion of a polyvinyl chloride resin copolymer. For ease of manufacture, the initial emulsion of polyvinyl chloride copolymer suspended in a non-aqueous solvent with one or more plasticizers may be a commercially available coating (Unituff 452—details available at http://unituffglobal.com/wp-content/uploads/2018/02/04-U452-4-4L_1G.UT-Unituff-452.pdf) which is not readily suitable for application in an aerosol container.

Other preferred examples of the resin that may be utilised for the said emulsion include polyvinyl acetate, polyvinyl propionate, polyvinylidene chloride, poly (methyl acrylate), poly (methyl methacrylate), poly (ethyl methacrylate), poly (butyl methacrylate), poly (propylacrylate), poly (butyl acrylate), copolymers of ethyl acrylate and methyl methacrylate, copolymers of butyl acrylate and methyl methacrylate and the like.

It is also important to appreciate that the starting emulsion may include other additives including plasticizers for the PVC. Some of the known plasticizers include dioctyl adipate (DOA) and/or trioctyl metallate (TOTM) in appropriate quantities (such as in range of 2 wt % to 25 wt %) to assist with plasticizing the PVC copolymers present in the starting emulsion.

Another important consideration in selection of the starting emulsion is that resins particularly those commonly used of the oil-in-water type, contain substantial quantities of water and emulsifying agent should be preferably avoided because applying such emulsions to corrodable metals such as mild steel, is likely to cause corrosion of the coated object even under ordinary indoor storage conditions.

Commonly used resins such as polyvinyl chloride and polyvinylidene chloride may be somewhat unstable when exposed to ultraviolet light such as is present in ordinary sunlight, especially in the presence of ultraviolet light. This disadvantage is aggravated by deterioration of the plasticizer normally present in the emulsion, and it often happens that the resin film alters by degradation in quality so as to be prone to corrode the coated metal object and derogate from the strippability of the film, when the coated object is placed in the weathering environment of the open air or in any environment of elevated temperature. This issue may be readily addressed by using a starting emulsion which also includes agents such as but not limited to zinc oxides and/or titanium oxides which are known to improve overall UV resistance. Other stabilisers may also be added to the starting emulsion.

The starting emulsion may also include a polar solvent such as but not limited to ethyl acetate and/or butyl acetate in an amount ranging from 7 wt % to 25 wt % for solubilizing the resin of the emulsion. In some embodiments, the starting emulsion may include more than one solvent for solubilizing the resin of the starting emulsion.

One of the non-limiting advantages of the presently described embodiment is that starting emulsion, that is suitable for providing corrosion inhibition by being coated on a metal substrate by way of being coated (analogous to a paint) but not suitable for being used in a pressurised aerosol container, may be processed by a novel method as described below to become more suitable for use as an aerosol composition. One of the key advantages provided by the use of a hand-held aerosol spray device is that a smooth film of the corrosion inhibiting coating may be provided on a metallic substrate by dispensing the aerosol composition of the preferred embodiment easily and efficiently. The inventors have surprisingly found that processing a starting emulsion of a resin (such as Unituff 452 as described earlier) by following a novel sequence of processing steps yields an aerosol composition that can be suitably applied by finely atomising the novel aerosol composition.

The initial step of preparing the aerosol composition involves measuring an initial starting quantity of the emulsion (such as the Unituff 452 formulation) in an amount in the range of 60 wt % to 90 wt % and more preferably in the range of 70 wt % to 80 wt % and even more preferably 74 wt % to 77 wt %. It is important to appreciate that weight percentage of the starting emulsion is described as a percentage relative to the overall weight of the aerosol composition. By way of example, in one embodiment, in order to produce 100 gms of the aerosol composition, 75 wt % of the Unituff 452 starting emulsion may be added into a mixing container or mixing chamber.

The next method step involves the addition of a thickening or anti-caking agent in an amount in the range of 0.5 wt % to 7 wt % and more preferably in the range of 3 wt % to 4 wt %. In some embodiments, the thickening agent may comprise particulate silica such as fumed or amorphous or pyrogenous silica. More preferably, hydrophobic colloidal silica may be used as a suitable thickening agent. Hydrophilic colloidal silica contains hydrophobic groups on its surface. Useful hydrophilic colloidal silicas may include Aerosil 130, Aerosil 150, Aerosil 200, Aerosil 300 and Aerosil 380 available from Degussa Corporation, and Cab-O-Sil fumed silica and Cab-O-Sil HS-5 available from Cabot Corporation. Preferred is Aerosil 300, which has a BET surface area of about 300 m²/gm. Useful hydrophobic colloidal silicas include Aerosil R202, Aerosil R805, AerosilR812, Aerosil R972 and Aerosil R976 available from Degussa Corporation, and Cab-O-Sil TS-530 available from Cabot Corporation. Aerosil R972, which has a BET surface area of about IIOm²/gm with about 70% of the surface hydroxyl groups methylated, may also be preferred.

Another important consideration is to uniformly mix the fumed silica thickening agent by dispersing the fumed silica well using a “saw tooth” blade in disperser with 5,000 feet per minute tip speed. If the emulsion is too thin or dilute, the fumed silica will not disperse well, so the mixer or disperser should be started when the fumed silica is introduced and run continuously until the silica is fully dispersed.

Once the fumed silica is fully dispersed, the next step involves adding another plasticizer to the mixture in an amount in the range of 1 wt % to 15 wt % or preferably in an amount in the range of 5 wt % to 10 wt % and more preferably in the range of 6 wt % to 7 wt %. A list of possible plasticizers may be viewed at http://www.sustainableproduction.org/downloads/PhthalateAlternatives-January2011.pdf. Some alternatives for plasticizers as follows. DOS: Dioctyl sebacate, TXIB: 2,2,4-trimethyl 1,3-pentanediol; diisobutyrate, TEHPA: Tri(2-ethylhexyl) phosphate, DEHPA: Di(2-ethylhexyl) phosphate, Eastman 168: bis(2-ethylhjexyl), 1,4-benzenedicarboxylate, TETM: Tri-2-ethylhexyl trimellitate; ESBO: Epoxidized soybean oil, DOTP: Dioctyl terephthalate; DINCH: Di-isononylcyclohexane-1,2-dicarboxylate.

The addition of the plasticizer is followed by the addition of a non-aqueous solvent. The present coating composition is a nonaqueous composition, wherein the starting emulsion (as previously described which already includes a solvent) is further diluted and dispersed in another non-aqueous carrier.

In general, is it preferable for the nonaqueous carrier to have sufficient volatility to evaporate essentially entirely from the aerosol composition once the aerosol composition has been sprayed to form the coating during the curing process which occurs at standard room temperature (25° C. or appx 70F). Suitable nonaqueous carriers may include for example, but are not limited to, glycol ethers, like ethylene glycol monomethyl ether, ethylene glycol monoethyl ether, ethylene glycol monobutyl ether, and propylene glycol monomethyl ether; ketones, like cyclohexanone, ethyl aryl ketones, methyl aryl ketones and methyl isoamyl ketone; aromatic hydrocarbons, like toluene, benzene and xylene; aliphatic hydrocarbons, like mineral spirits, kerosene and high flash VM&P naphtha; alcohols, like isopropyl alcohol, n-butyl alcohol and ethyl alcohol; and aprotic solvents, like tetrahydrofuran; chlorinated solvents; esters; glycol ether esters, like propylene glycol monomethyl ether acetate; and combinations thereof.

The non-aqueous carrier usually is included in the composition in a sufficient amount to provide a composition including from about 5 wt % to about 35 wt %, by weight of the aerosol composition. The amount of non-aqueous carrier included in the composition is limited only by the desired, or necessary, rheological properties of the aerosol composition. Usually, a sufficient amount of non-aqueous carrier is included in the coating composition to provide a composition that can be atomised easily so that atomised droplets of the aerosol composition can be evenly spread over a metal substrate. Any non-aqueous carrier is useful in the present coating composition as long as the non-aqueous carrier adequately disperses and/or solubilizes the composition components of the starting emulsion (such as the Unituff 452) and the other constituents such as the thickening agent and the plasticizer. It is also important to take into consideration that the non-aqueous carrier is inert with respect to interacting with the other aerosol composition components and does not adversely affect the stability of the coating formed by spraying or dispensing the aerosol composition on the metallic substrate. The non-aqueous carrier must also not affect the ability of the aerosol composition to inhibit corrosion of a metal substrate and should therefore evaporates quickly, essentially entirely and relatively rapidly at room temperature conditions to provide a cured coating composition within a drying time of a few minutes (preferably in the range of a few minutes) and a curing time of no more than a few days that inhibits the corrosion of a metal substrate, demonstrates good adhesion and flexibility, and has good chemical and physical properties.

The aerosol composition may be poured into a conventional type of aerosol container indicated generally by 120. The inner surfaces of the metal aerosol can 120 are preferably coated may be coated with an anti-corrosion film. The aerosol composition may be contained in the lower portion of the can below the compressed propellant. In the presently described embodiment once the propellant is added into the aerosol container 120 and pressurised to a pressure in the range of 75-125 psi, preferably 80 psi, the volume ratio of the propellant (preferably dimethyl ether-DME) to the aerosol composition when contained in a pressurized aerosol dispenser ranges from 60:40 to 50:50. In order to help obtain the proper distribution of the constituents of the aerosol composition, a metallic sphere may be placed in the aerosol container to aid in agitating the aerosol composition when the can 120 is shaken prior to discharge of the aerosol composition. During the discharge operation, the paint formulation in which, as discussed below, a portion of the propellant is entrained, is discharged through the dip tube 110 which is force-fitted over the annular neck 111 leading into the valve structure of the aerosol container.

In the aerosol container 120 shown in the drawing, the upper portion of the walls of the container 120 terminate in cylindrical portion 160 which is crimped at the top of the aerosol container 120. Within the crimped section, there is provided a seal between the surfaces of the side portion and top. The top of the container 120 is shaped so as to hold the valve body 122 and is also shaped so as to retain an annular gasket in a conventional manner. A push button actuator 140 is spring loaded by a spring body 142 such that upon being pushed by the actuator 140, the spring body activates the valve body 122 to allow pressurised propellant and the aerosol composition to flow into the upper cylindrical cavity 160. The actuator body 140 includes a passageway for receiving and directing the propellant and aerosol mixture out of a discharge outlet 144. When the pushbutton actuator 140 is depressed, a central portion of the valve body 122 may be moved downward so that the ports provided along the valve body are moved away from the walls of the gasket and the aerosol composition to be discharged flows up the dip tube 110 to the bottom of the valve body 122 through the valve body 122 through the ports 29. The valve may be preferably biased to the closed position by the upward push of the spring body 142. The actuator 140 is countersunk into the upper chamber 160 and whilst the actuator is depressed in a downward state, the inlet port on the actuator body 140 moves past another gasket and communicates with the upper chamber 160 to receive the aerosol composition. The aerosol composition is conveyed by the passageway in the actuator body 140 and released out from the outlet 144.

As indicated, the aerosol formulation in combination with the propellant can be discharged from the aerosol spray device 100 without the formation of unwanted foams or strings of discharged formulation but with the proper atomization of the discharge spray. It is preferred for best results, however, that a mechanical break-up device be utilized to promote the optimum atomization of the discharged paint spray. In one embodiment, a nozzle orifice of approximately 0.016 inch to about 0.020 inch in diameter may be suitable for many applications. As known in the art, the dimensions of the orifice may be varied depending upon the actual viscosity and pigment content of the aerosol composition that is employed for optimum results.

It is particularly surprising that a relatively insoluble propellant such as DME blends and mixes with the aerosol composition of the presently described embodiment to a sufficient degree to greatly enhance the atomization of the aerosol composition as the propellant and aerosol composition mixture is discharged through the nozzle. No noticeable foaming was observed and uniform and thin films were readily deposited from the aerosol spray device 100.

The novel aerosol composition in accordance with at least some of the embodiments of the presently described invention is particularly well suited for use in forming a thin strippable film (formed from cured resins) when sprayed on a metallic substrate. The aerosol composition was that adheres to smooth metallic surfaces but still allows the aerosol composition dispensed easily through a conventional propellant based aerosol container having a conventional dispensing mechanism and it is hypothesized that the novel composition particularly the combination of the starting emulsion with a novel combination of the anti-thickening agent, the additional plasticizer and the solvent makes the novel composition more suitable for its intended use (corrosion prevention of metallic substrate) for dispensation through the conventional propellant based aerosol container.

### Example 1

A starting emulsion of Unituff 452 in amount of 74.75 wt % was added into a sawtooth disperser. Thereafter, 3.25 wt % of a thickening agent in the form of fumed silica, Aerosil R972 (Silane dichlorodimetyl-CAS No. 68611-44-9) was added gradually into the starting emulsion to uniformly mix the fumed silica into the starting emulsion of Unituff 452. Once the fumed silica had been thoroughly mixed into the starting emulsion at a sawtooth tip speed of 5000 feet per second, 6.00 wt % of a plasticizer, namely Eastman 168 (non-phthalate plasticizer manufactured by Eastman Chemical Company) was added to the mixture of the fumed silica and the starting emulsion. Finally, a non-aqueous carrier in the form of 16.00 wt % n-Butyl Alcohol was added to achieve the final aerosol composition.

| Product | PPH (wt) |
|---|---|
| UniTuff 452 base | 74.75% |
| product | |
| Aerosil R972 | 3.25% |
| Eastman 168 (non- | 6.00% |
| phthalate plasticizer) | |
| N-Butyl Alcohol | 16.00% |

### Example 2

A starting emulsion was prepared by selecting a clean and dry vessel. A first and second plasticizer namely Dioctyl Adipate (DOA) and Trioctyl Trimellitate (TOTM) were added in initial amounts in the range of 1 wt % to 5 wt % and 2 wt % to 10 wt % respectively. This step was followed by addition of a solvent soluble polyurethane dispersion product (29N obtained from BW Chemicals) in an amount in the range of 2 wt % to 5 wt %. A very small quantity (in amount in the range of 0.05 wt % to 2 wt %) of Aluminium paste (STAPA 4 or 5) was added to the mixture under stirring for an extended time period of greater than 5 minutes and more preferably greater than 10 minutes in a controlled temperature environment of under 100° C. Additional plasticizer in the form TOTM was once again added to the mixture in an amount in the range of 2 wt % to 10 wt % and a first mixture was obtained. In a separate vessel, alkyl acetates (such as but not limited to ethyl acetate and butyl acetate) in an amount in the range of 15 wt % to 30 wt % were blended with a large quantity of acetone (preferably in the range of 30 wt % to 50 wt %) by continuous stirring until the blended appeared to be homogenous. A combination of a first Polyvinyl Chloride resins (SVR CK) and a second Polyvinyl Chloride Resin (SVR UM50) (in relative weight ratio of 2:1) was added to the homogenous blend in an amount in the range of 15 wt % to 30 wt % under stirring and known dispersion techniques were adopted to ensure that the resins were dissolved. The first mixture containing the plasticizers was slowly added to the homogenous blend of organic solvent and the vinyl resin to form the starting emulsion.

The starting emulsion in amount of 74.75 wt % was then added into a sawtooth disperser. Thereafter, 3.25 wt % of a thickening agent in the form of fumed silica, Aerosil R972 (Silane dichlorodimetyl-CAS No. 68611-44-9) was added gradually into the starting emulsion to uniformly mix the fumed silica into the starting emulsion. Once the fumed silica had been thoroughly mixed into the starting emulsion at a sawtooth tip speed of 5000 feet per second, 6.00 wt % of a plasticizer, namely Eastman 168 (non-phthalate plasticizer manufactured by Eastman Chemical Company) was added to the mixture of the fumed silica and the starting emulsion. Finally, a non-aqueous carrier in the form of 16.00 wt % n-Butyl Alcohol was added to achieve the final aerosol composition.

| Product | PPH (wt) |
|---|---|
| Starting Emulsion | 74.75% |
| Aerosil R972 | 3.25% |
| Eastman 168 (non- | 6.00% |
| phthalate plasticizer) | |
| N-Butyl Alcohol | 16.00% |

Once again, the aerosol composition was filtered to remove any solid agglomerates before being transferred or poured into an aerosol container. ⅔^{rd} volume of the aerosol can (under pressure of 80 psi) was occupied by a compressed propellant, namely DME and ⅓^{rd} of the volume of the aerosol can was occupied by the aerosol composition of Example 1.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. A quick drying aerosol composition for coating a metal substrate for inhibiting corrosion, wherein droplets of the quick drying aerosol composition are adapted to be discharged from an aerosol spray device, the quick drying aerosol composition comprises: a resin composition comprising a resin in an amount in the range of 10 wt % to 60 wt %, the resin being selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, polyvinyl chloride, polyvinylidene chloride and copolymers thereof; one or more thickening or anti-caking agents in an amount in the range of 0.5 wt % to 7 wt %; a plasticizer in an amount in the range of 1 wt % to 15 wt % compatible with the resin; and a non-aqueous carrier/solvent in an amount 5 wt % to 35 wt %, wherein the resin is in an amount in the range of about 5 wt % to about 25 wt % of the resin composition.

2. A quick drying aerosol composition for coating a metal substrate in accordance with claim 1 wherein the resin is one of the following: polyvinyl chloride, polyvinylidene chloride, polyvinyl acetate and poly (lower alkyl) acrylates.

3. A quick drying aerosol composition for coating a metal substrate in accordance with claim 1 wherein the group comprises polyvinyl chloride resins, polyvinyl acetate resins, vinyl chloride-vinyl acetate copolymeric resins, acrylic resins, polyvinyl alcohols.

4. A quick drying composition in accordance with claim 1, wherein the resin in the resin composition is an amount in the range of 10 wt % to 30 wt % and more preferably in the range of 10 wt % to 20 wt %.

5. A quick drying aerosol composition in accordance with claim 1 wherein the thickening or anti-caking agent comprises particulate silica such as fumed or amorphous or pyrogenous silica.

6. A quick drying aerosol composition in accordance with claim 1 wherein the thickening or anti-caking agent is present in an amount ranging from 0.5 wt % to 4.5 wt % and more preferably between 2 wt % and 4 wt %.

7. A quick drying aerosol composition in accordance with claim 1 wherein the thickening or anti-caking agent comprises hydrophobic particulate silica with a BET surface area in range of 50 to 300 m²/gm and more preferably 110 m²/gm.

8. A quick drying aerosol composition in accordance with claim 1 wherein the plasticizer is a non-phthalate plasticizer.

9. A quick drying aerosol composition in accordance with claim 1 further comprising a propellant such that volume ratio to the aerosol composition when contained in a pressurized aerosol dispenser at a pressure in range of 35-105 psi at 70° F., ranges from 80:20 to 50:50.

10. A quick drying aerosol composition in accordance with claim 1 wherein the non-aqueous carrier/solvent comprises alcohols, such as methanol, ethanol, propanol and butanol; aliphatic hydrocarbons, such as hexane and pentane; aromatic hydrocarbons, such as benzene, toluene and xylene; ketones, such as acetone and methylethylketone; ethers such as diethylether, dioxane and tetrahydrofuran; esters, such as ethyl acetate, propyl acetate and butyl acetate; and halogenated hydrocarbons, such as trichloroethylene and carbon tetrachloride.

11. A quick drying aerosol composition in accordance with claim 9 wherein the propellant is selected from a group comprising one or more of the following: dimethyl ether, pentaflurodimethyl ether, Perfluorodimethyl ether and its derivatives.

12. An aerosol spray device for applying a corrosion inhibiting composition on a metallic substrate, the device comprising:
container that contains the quick drying aerosol composition in accordance with claim 1 wherein the container is adapted to pressurize the quick dry aerosol composition;
a dispensing passageway having a discharge opening; and
valve for dispensing the quick drying aerosol composition,
a dip tube extending from the valve to the quick drying aerosol composition in the container,
wherein in response to displacement of an actuator member into an open position, the quick drying aerosol composition is discharged from the container into the dispensing passageway and out of the discharge opening.

13. An aerosol paint product for inhibiting corrosion by coating a substrate with a quick drying aerosol composition to form a strippable or peelable coating, the product comprising:
a container containing the quick drying aerosol composition comprising: a resin composition comprising a resin in an amount in the range of 10 wt % to 60 wt % selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof; one or more thickening or anti-caking agents in amount in the range of 0.5 wt % to 7 wt %;
a plasticizer in an amount in the range of 1 wt % to 15 wt % compatible with the resin; and a non-aqueous carrier/solvent in an amount 5 wt % to 35 wt %;
a dispensing passageway having a discharge opening; and
valve for dispensing the quick drying aerosol composition,
a dip tube extending from the valve to the quick drying aerosol composition in the container,
wherein in response to displacement of an actuator member into an open position, the quick drying aerosol composition is discharged from the container into the dispensing passageway and out of the discharge opening.

14. A method of producing a quick drying aerosol composition for coating a metal substrate for inhibiting corrosion, the method comprising the steps of:
providing a starting resin composition, the resin composition comprising being in an amount in the range of 45 wt % to 85 wt %, the resin selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof;
dispersing one or more thickening or anti-caking agents in amount in the range of 0.5 wt % to 7 wt % through the resin composition to attain a uniformly dispersed mixture comprising the resin composition and the thickening or anti-caking agent;
adding a plasticizer to the mixing amount in the range of 1 wt % to 15 wt % to the uniformly dispersed mixture; and
adding a non-aqueous solvent in an amount in the range of 5 wt to 35 wt % to the uniformly dispersed mixture after adding the plasticizer to form a blended mixture.

15. A method of producing the quick drying aerosol composition in accordance with claim 14 wherein the amount of resin in the starting resin composition is an amount in the range of 5 wt % to 25 wt % and more preferably in the range of 10 wt % to 20 wt %.

16. A method of producing the quick drying aerosol composition in accordance with claim 14 wherein the step of dispersing the thickening or anti-caking agents comprises using a saw tooth disperser for dispersing the thickening or anti-caking agents at a tip speed of with 5,000 feet per minute tip speed.

17. A method of producing the quick drying aerosol composition in accordance with claim 14 further comprising the steps of:
filtering the blended mixture to separate any solid agglomerates from the blended mixture; and
pouring the filtered blended mixture into an aerosol container;
adding a propellant into the aerosol container and pressurising the aerosol container to a pressure in the range of 35-105 psi such that such that volume ratio of the propellant to the quick drying aerosol composition when contained in a pressurized aerosol dispenser ranges from 80:20 to 50:50.

18. A method of producing the quick drying aerosol composition in accordance with claim 14 wherein the starting resin composition is prepared by adding the resin in a range of 8 wt % to 25 wt % and more preferably in the range of 10 wt % to 20 wt % in a first group of solvents, the first group of solvents being in the range of 40 wt % to 70 wt % and more preferably in the range of 55 wt % to 65 wt %.

19. A method of producing the quick drying aerosol composition in accordance with claim 18 wherein the first group of solvents comprises one or more of alcohols, such as methanol, ethanol, propanol and butanol; aliphatic hydrocarbons, such as hexane and pentane; aromatic hydrocarbons, such as benzene, toluene and xylene; ketones, such as acetone and methylethylketone; ethers such as diethylether, dioxane and tetrahydrofuran; esters, such as ethyl acetate, propyl acetate and butyl acetate; and halogenated hydrocarbons, such as trichloroethylene and carbon tetrachloride.

20. A method of producing the quick drying aerosol composition in accordance with claim 14 wherein the starting resin composition is prepared by addition of a first group of plasticizers in the range of 5 wt % to 20 wt %, the plasticizers comprising one or more of the following: dioctyl adipate (DOA) and/or trioctyl metallate (TOTM); DOS: Dioctyl sebacate, TXIB: 2,2,4-trimethyl 1,3-pentanediol; diisobutyrate, TEHPA: Tri(2-ethylhexyl) phosphate, DEHPA: Di(2-ethylhexyl) phosphate, Eastman 168: bis(2-ethylhjexyl), 1,4-benzenedicarboxylate, TETM: Tri-2-ethylhexyl trimellitate; ESBO: Epoxidized soybean oil, DOTP: Dioctyl terephthalate; DINCH: Di-isononylcyclohexane-1,2-dicarboxylate.

21. A method of producing the quick drying aerosol composition in accordance with claim 14 wherein the starting resin composition is prepared by addition of a solvent soluble polyurethane dispersion in an amount in the range of 2 wt % to 5 wt %.

22. A method of coating a metallic substrate comprising the steps of:
applying a quick drying aerosol composition on the metal substrate to form a coating thereon for inhibiting corrosion;
wherein droplets of the quick drying aerosol composition are adapted to be discharged from an aerosol spray device and wherein the quick drying aerosol composition comprises: a resin composition, the a resin composition being in an amount in the range of 45 wt % to 85 wt % and wherein the resin is selected from the group consisting of polyvinyl lower acyl esters in which the acyl has from two to five carbon atoms, poly (lower alkyl) acrylates in which the alkyl has from one to four carbon atoms, poly (lower alkyl) methacrylates in which the alkyl has from one to four carbon atoms, and copolymers thereof; one or more thickening or anti-caking agents in amount in the range of 0.5 wt % to 7 wt %; a plasticizer in an amount in the range of 1 wt % to 15 wt % compatible with the resin; and a non-aqueous carrier/solvent in an amount 5 wt % to 35 wt %.

23. The quick drying aerosol composition in accordance with claim 1 to 11, wherein the resin composition is an emulsion.

24. The quick drying aerosol composition in accordance with claim 1 to 11, wherein the resin composition is UniTuff 452.
